(19) United States
(12) Patent Application Publication
(10) Pub. No.: US 2023/0210174 A1
(43) Pub. Date: Jul. 6, 2023

(54) SHORT-CIRCUIT AND LEAK PROOF VAPORIZING DEVICES AND METHODS OF USE OR MANUFACTURE THEREOF

(71) Applicant: Next Level Ventures LLC, Seattle, WA (US)

(72) Inventor: Jin Qiu Xiujin, Shenzhen (CN)

(21) Appl. No.: 18/092,722

(22) Filed: Jan. 3, 2023

(30) Foreign Application Priority Data
Jan. 4, 2022 (CN) 202220034192.8
Apr. 8, 2022 (CN) 202220806819.7

(51) Int. Cl. A24F 40/42; A24F 40/10; A24F 40/44; A24F 40/485; A24F 40/46; A24F 7/02

(52) U.S. Cl. CPC A24F 40/42; A24F 40/10; A24F 40/44; A24F 40/485; A24F 40/46; A24F 7/02; H05B 3/16

(57) ABSTRACT

This disclosure relates generally to vaporizing devices having short-circuit and leak proof capabilities. Specifically, embodiments of the present disclosure provide vaporizing devices including an atomizer wrapped with a non-woven wick and received by a distal cavity in a center post. The non-woven wick is in fluid communication with a reservoir, placing the atomizer also in fluid communication with the reservoir. Fluid travels from the reservoir, through the wick, to the atomizer to be atomized, and vaporized fluid can be pulled proximally out of the vaporizing device. A clearance of approximately 1.0 to 2.5 mm separates a top surface of the atomizer from a top surface of the distal cavity. The vaporizing devices additionally include an electrode (e.g., an anode) in electrical communication with an anode wire of the atomizer. An insulating sleeve maintains the position of the anode wire against the electrode, allowing for good electrical conductivity and communication.

### PRIORITY CLAIM

This application claims priority to Chinese patent application no. 202220034192 .8, filed Jan. 4, 2022, and Chinese patent application no. 202220806819.7, filed Apr. 8, 2022. Chinese patent application nos. 202220034192.8 and 202220806819.7 are incorporated herein by reference in their entireties.

### TECHNICAL FIELD

This disclosure relates generally to vaporizing devices and, particularly, to short-circuit and/or leak proof vaporizing devices. The present disclosure also relates to methods of manufacturing and use thereof.

### SUMMARY

In various aspects, embodiments of the present disclosure provide for short-circuit and/or leak proof vaporizing devices. In some embodiments, disclosed devices include a reservoir having or defining an interior to receive a center post. A base housing an insulator (e.g., an electrode silicone sleeve) is attached to a bottom or distal end of the center post. The disclosed devices additionally include an insulating sleeve for receiving or surrounding an anode, where the anode includes a first cavity disposed at a top portion of the anode and a second cavity disposed at a bottom portion of the anode. The first and second cavities are associated with a first and second plurality of through holes, respectively.

In some embodiments, the distal end of the center post is configured to receive an atomizer or heating element. For example, the distal end of the center post can define a cavity or housing sized and shaped to receive, at least, the atomizer. A clearance or gap of about or approximately 1.0 to 2.5 mm is arranged between the atomizer and a top of the cavity. Providing the clearance or gap between the atomizer and the top of the cavity prevents liquids or a substance to be vaporized from leaking during operation of the vaporizing device.

The anode is designed and configured to be an isolating structure, which works together with the insulating sleeve to isolate an anode wire of the atomizer. The disclosed devices are arranged to ensure adequate and sufficient electrical conductivity and air conductivity. Additionally, isolating the anode wire of the atomizer prevents blockage of the atomizer and avoids impacting airflow through the device. Isolating the anode wire also prevents leakage of liquids or the substance to be vaporized from the bottom of the base and/or reservoir. Further, the disclosed devices are more easily manufactured, meaning the production process can be largely automated.

In some embodiments, the disclosed devices can include a mouthpiece and a mouthpiece locking structure for connecting or otherwise engaging the mouthpiece and the proximal end of the center post.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 illustrates one example of a vaporizing device, according to embodiments of the present disclosure.

FIG. 2 illustrates an exploded view of the vaporizing device of FIG. 1.

FIG. 3 illustrates a cross-sectional view of the vaporizing device of FIG. 1.

FIG. 4 illustrates a close-up cross-sectional view of part A from the vaporizing device of FIG. 3.

FIG. 5 illustrates a close-up cross-sectional view of part B from the vaporizing device of FIG. 3.

FIG. 6 illustrates an example anode, according to embodiments of the present disclosure.

FIG. 7 illustrates another example of a vaporizing device, according to embodiments of the present disclosure.

FIG. 8 illustrates an exploded view of the vaporizing device of FIG. 7.

FIG. 9 illustrates a cross-sectional view of the vaporizing device of FIG. 7.

FIG. 10 illustrates a cross-sectional exploded view of the vaporizing device of FIG. 7.

FIG. 11 illustrates a flowchart of an example method for manufacturing a vaporizing device, according to embodiments of the present disclosure.

### DETAILED DESCRIPTION

Vaporizing devices generally apply heat to a substance (i.e., a liquid or oil) in order to vaporize the substance for inhalation. Vaporizing devices are typically easier to use than conventional smoking devices (e.g., cigarettes). Additionally, vaporizing substances for inhalation rather than burning them provides a more pleasing flavor of the substance.

Typically, during assembly of vaporizing devices, the heating element (e.g., an atomizer, a heating core, or coil) is disposed inside an internal cavity of the vaporizing device. However, the placement of the heating element within the internal cavity generally leaves little to no space or clearance between the heating element and the internal cavity. In other words, the heating element is tightly packed within the internal cavity. This tight fit can lead to leakage of the liquid from the vaporizing device.

Additionally, the heating element is often held in place within the internal cavity by means of an insulating ring. Inclusion of the insulating ring, however, improperly positions anode and/or cathode wires of the heating element within the vaporizing device. The poor placement can result in poor or inadequate contact between the anode/cathode wires and the source of current, resulting in poor electrical conductivity through the heating element. This can lead to unstable resistance of the anode/cathode wires or inconsistent current flow which has a direct impact on efficiency of the heating element and, thus, the amount of vapor produced. In other words, such tight placement of the heating element and its anode/cathode leads to short-circuiting of the heating element. Further, inclusion of the insulating ring decreases production efficiency in manufacturing these devices.

In addition to resulting in poor or inadequate electrical conductivity, inclusion of the insulating ring leads to buildups or blockages in the heating element. These blockages impact the flow and stability of airflow through the device and contribute to leakage of the liquid from the device. The presence of the insulating ring also increases the difficulty of manufacturing these vaporizing devices, complicating the automatic production process and increasing the costs of the vaporizing devices.

The present disclosure addresses these and other problems. For example, embodiments of the present disclosure provide devices that are substantially leakproof and prevent liquid or oil contained within the device from leaking out. Additionally, embodiments of the present disclosure provide devices having improved electrical conductivity, allowing the devices to be substantially “short-circuit proof.”

In various aspects, embodiments of the present disclosure provide for short-circuit and/or leak proof vaporizing devices. In some embodiments, disclosed devices include a reservoir or tank having or defining an interior to receive a center post. A base housing an insulator (e.g., an electrode silicone sleeve) is attached to or otherwise in connection with a bottom or distal end of the center post. The disclosed devices additionally include an insulating sleeve for receiving or surrounding an electrode (e.g., an anode), where the electrode includes a top cavity disposed at a top portion of the electrode and a bottom cavity disposed at a bottom portion of the electrode. The top and bottom cavities are associated with a first and second plurality of through holes, respectively.

In some embodiments, the distal end of the center post is configured to receive an atomizer or heating element. For example, the distal end of the center post can define a cavity sized and shaped to receive, at least, the atomizer. A clearance or gap of approximately 1.0 to 2.5 mm is arranged between the atomizer and a top of the cavity. Providing the clearance or gap between the atomizer and the top of the cavity reduces and/or prevents liquids or a substance to be vaporized from leaking during operation of the vaporizing device. Any suitable atomizer or heating element can be used. For example, heating elements that consist of a wire within a ceramic core are common. Various types of metals for the wire, and various types of ceramic can be used. For example, the heating element can include a thin wire of titanium, aluminium, or any other suitable metal, such as magnesium, zirconium, zinc, niobium, vanadium, hafnium, tantalum, molybdenum, tungsten, antimony, bismuth, or an alloy of one or more of the preceding metals.

The vaping system can also include an electrode that is designed and configured to be an isolating structure, which works together with the insulating sleeve to isolate an anode wire of the atomizer. The disclosed devices are arranged to ensure adequate and sufficient electrical conductivity and air conductivity. Additionally, isolating the anode wire of the atomizer prevents blockage of the atomizer (e.g., prevents blockage of pores) and avoids impacting airflow through the device. Isolating the anode wire also prevents leakage of liquids or the substance to be vaporized from the bottom of the base. Further, the disclosed devices are more easily manufactured, meaning the production process can be largely automated.

In some embodiments, the disclosed devices can include a mouthpiece and a mouthpiece locking structure for connecting the mouthpiece and the proximal end of the center post.

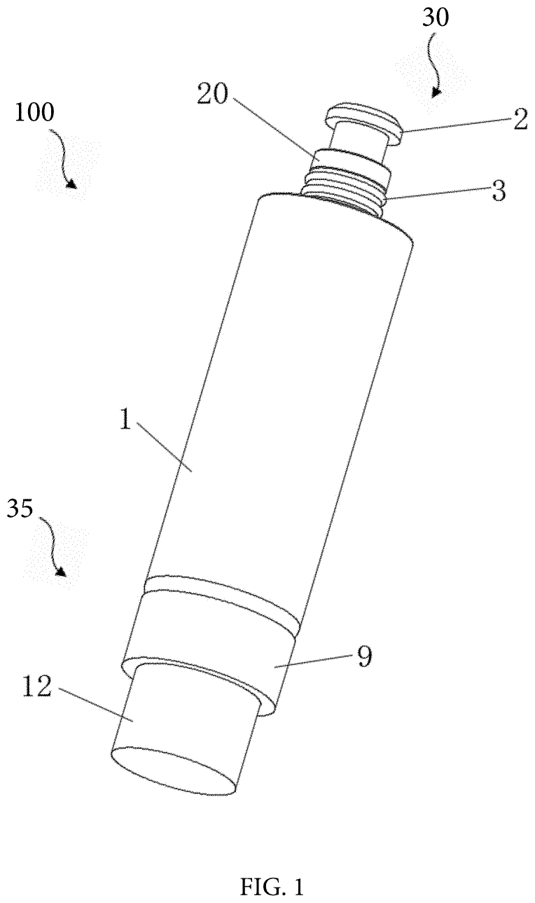

FIG. 1 illustrates one example of a vaporizing device 100, according to embodiments of the present disclosure. In some embodiments, the vaporizing device 100 is a leakproof device. In some embodiments, the vaporizing device 100 can be a cartridge or liquid reservoir. As illustrated, the vaporizing device 100 includes a reservoir or tank 1, a center post 2, a base 9, and an endcap cap 12. The base 9 is attached to or otherwise in connection with a distal end 35 of the center post 2. The vaporizing device 100 also includes a pair of proximal flanges 20 (only one flange of the pair is illustrated) disposed near a proximal end 30 of the center post 2, and a first sealing ring 3. In some embodiments, the first sealing ring 3 is disposed between the pair of proximal flanges 20.

The center post 2 is received or positioned in an interior of the reservoir 1. For example, the center post 2 can be positioned within the interior of the reservoir 1 in a sleeved or nested manner. The proximal end 30 of the center post 2 extends proximally beyond a proximal end of the reservoir or tank 1. In some embodiments, the proximal end 30 engages with or receives a mouthpiece and/or a mouthpiece locking structure. The distal end 35 of the center post 2 extends distally beyond a distal end of the reservoir 1. In this way, the distal end 35 of the center post 2 can engage with the base 9.

In some embodiments, the endcap 12 can be a silicone cap. In other embodiments the endcap 12 is made from a different material. Or, an endcap 12 may not be provided. In some embodiments, the center post 2 can be a metal, such as stainless steel, and/or a metal alloy. In other embodiments, the center post 2 can be formed of ceramic or any other suitable materials.

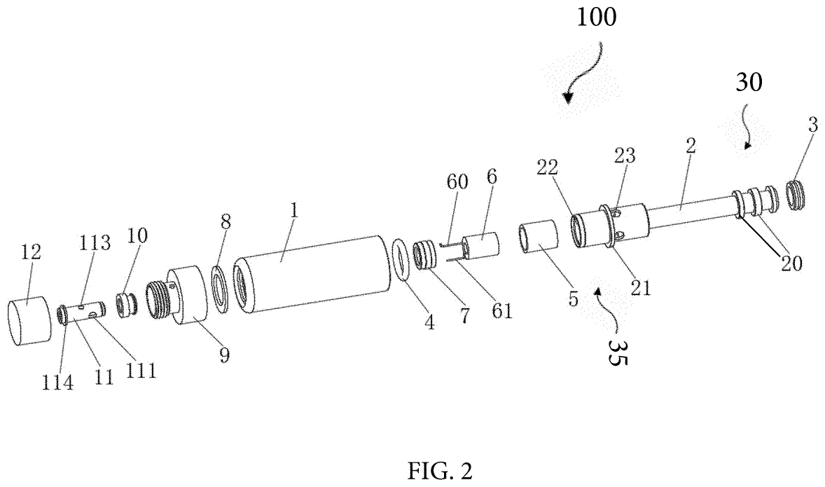

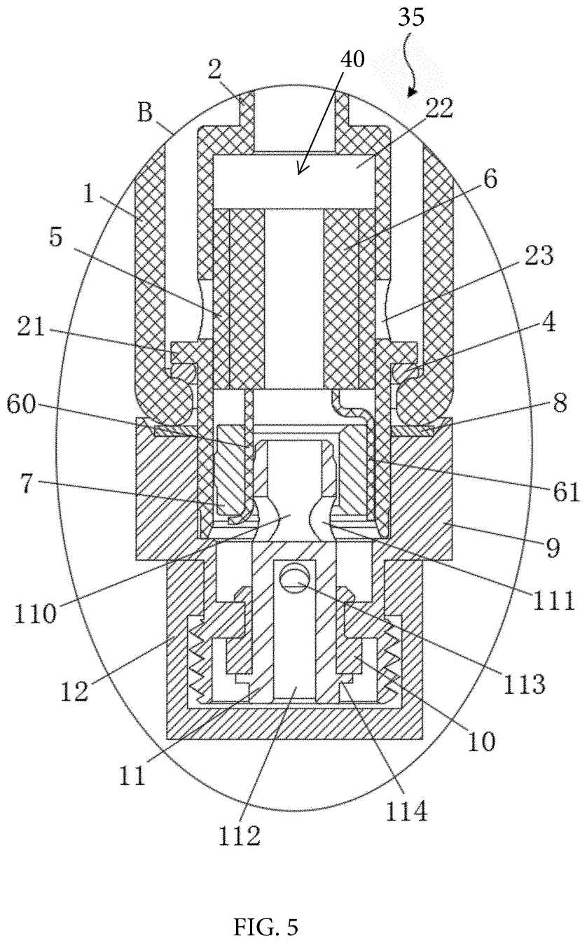

FIG. 2 illustrates an exploded view of the vaporizing device 100 of FIG. 1. As illustrated, the vaporizing device 100 includes the reservoir 1, the center post 2, the base 9, and the endcap 12. The pair of proximal flanges 20 can clearly be seen disposed near the proximal end 30 of the center post 2. The distal end 35 of the center post 2 defines a cavity 22 (better illustrated in FIG. 5) and one or more voids 23. The distal end 35 also includes a distal flange 21. In some embodiments, the one or more voids are disposed just proximal to the distal flange 21. The cavity 22 is sized to receive or house a heating element/atomizer within the cavity 22 of the distal end 35 of the center post 2.

Also illustrated are various internal components of the vaporizing device 100 that are housed or otherwise disposed within (i) the cavity 22 of the distal end 35 of the center post 2, (ii) the base 9, or (iii) some combination thereof. The internal components can include, at least, a non-woven wick 5, a heating element or atomizer 6 having an anode wire 60 and a cathode wire 61, and an insulating sleeve 7. The internal components can also include an anode 11 (i.e., the electrode) and an insulator 10. Also illustrated are second and third sealing rings 4, 8 which assist in providing leakproof and other seals during manufacture, assembly, and/or use of the vaporizing device 100.

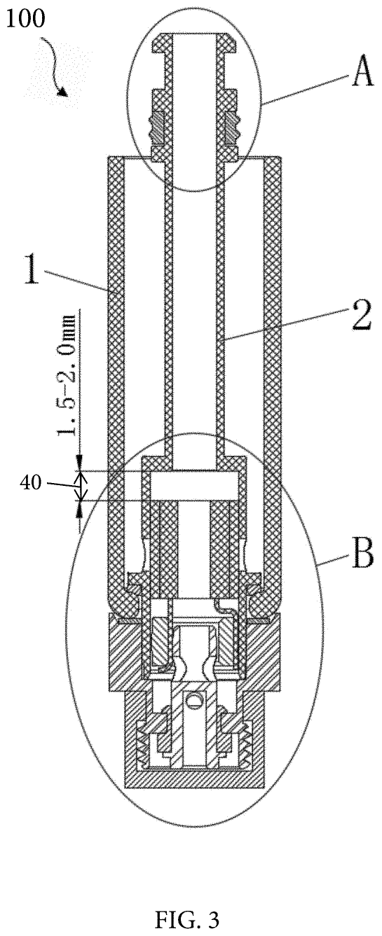

FIG. 3 illustrates a cross-sectional view of the vaporizing device 100 of FIG. 1. FIG. 3 illustrates the nested or sleeved relationship of the center post 2 within the interior of the reservoir 1. As shown, the proximal end 30 of the center post 2 extends proximally beyond a proximal end of the reservoir 1. As can also be seen, the base 9, when connected to the distal end 35 of the center post 2, abuts a distal end of the reservoir 1. FIG. 3 additionally illustrates a gap or clearance 40 that is disposed between a top surface of the atomizer and a top surface of the cavity 22 defined by the distal end 35 of the center post 2.

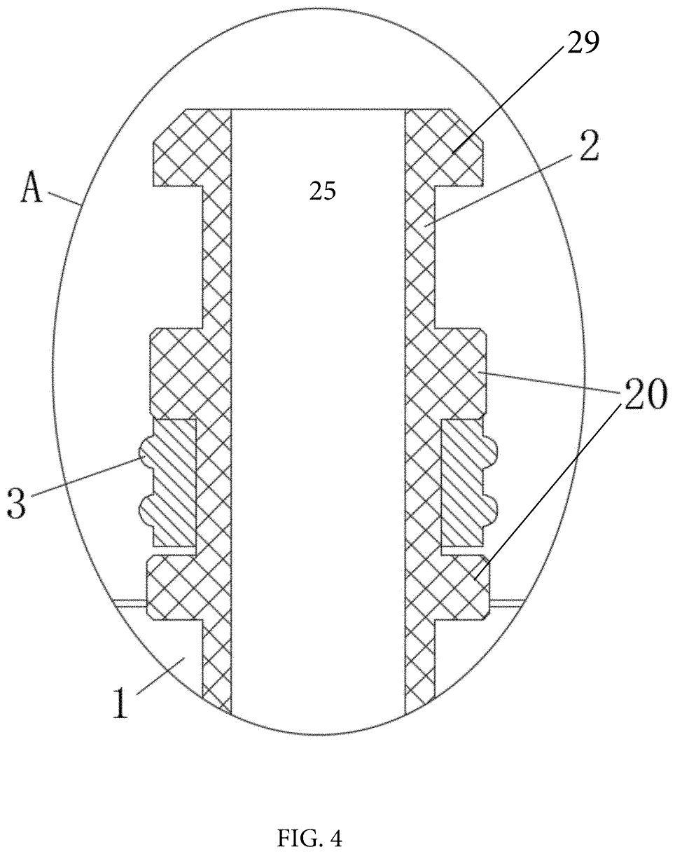

FIG. 4 illustrates a close-up cross-sectional view of section A of the vaporizing device from FIG. 3. The first sealing ring 3 is clearly seen as being disposed between the pair of proximal flanges 20. In some embodiments, the most proximal end of the center post 2 includes a lip or additional flange 29. In some embodiments, the lip 29 may be configured to engage with a mouthpiece or a mouthpiece locking structure (discussed more fully below). As clearly shown, the center post 2 defines an internal channel 25.

FIG. 5 illustrates a close-up cross-sectional view of section B from the vaporizing device of FIG. 3. Specifically, FIG. 5 illustrates a cross-sectional view of the distal end 35 of the center post 2, a distal end of the reservoir 1, and the base 9. A first portion of the distal end 35 of the center post 2 is disposed within the distal end of the reservoir 1. A second portion of the distal end 35 of the center post 2 extends beyond the distal end of the reservoir 1 and connects or otherwise engages with the base 9.

As shown, the distal end 35 of the center post 2 defines a housing or cavity 22. In some embodiments, the cavity 22 is sized and shaped to house a heating element or atomizer 6, among other components. In some embodiments, the atomizer 6 is wrapped with a non-woven sleeve 5, such as a non-woven wick. In some embodiments, the non-woven wick 5 acts to draw fluid or liquid from the reservoir toward the atomizer so the fluid can be atomized. The non-woven wick 5 can include any non-woven material, such as felt or other fabrics. Additionally, and/or alternatively, the non-woven wick can include wood, cotton, paper, or other appropriate non-woven materials. In other embodiments, a non-woven sleeve is not provided. In yet other embodiments, a woven sleeve can be used.

The one or more voids 23 defined by the distal end 35 additionally place the atomizer in fluid communication with the reservoir 1. As shown, the one or more voids 23 are disposed just proximal of the distal flange 21. The non-woven wick 5 surrounds the atomizer 6, such that a fluid from the reservoir passes through the one or more voids 23 in the distal end 35 of the center post 2, through the non-woven wick 5, and to the atomizer 6. The fluid will then be atomized and drawn proximally through the internal channel (see internal channel 25 of FIG. 4) of the center post 2.

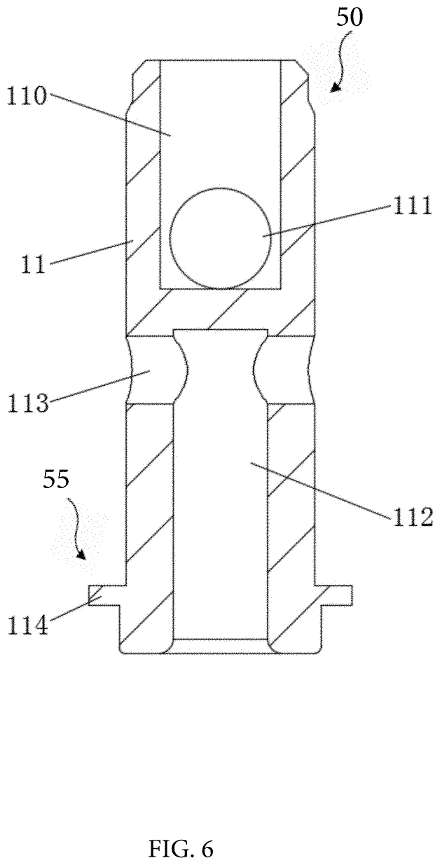

FIG. 5 also illustrates the anode 11 disposed within the base 9 and the cavity 22. In some embodiments, the anode 11 is, more generally, an electrode or any other conductive material such as conductive tubing, a conductive conduit, etc. Specifically, the anode 11 is configured to supply current to the anode wire 60 to ultimately power the heating element or atomizer 6. In some embodiments, a top portion 50 of the anode 11 is contained within the cavity 22 and a bottom portion 55 of the anode 11 is contained within the base 9 (see top and bottom portions 50, 55 in FIG. 6). The top portion of the anode 11 defines a top cavity 110 having a first plurality of through holes 111. The bottom portion of the anode 11 defines a bottom cavity 112 having a second plurality of through holes 113. As shown, the insulator 10 is disposed around the bottom portion of the anode 11. In some embodiments, the insulator 10 is disposed between the bottom portion of the anode 11 and an interior distal surface of the base 9.

In some embodiments, the first plurality of through holes 111 are disposed symmetrically about the top portion of the anode 11. In some embodiments, the second plurality of through holes 113 are disposed symmetrically about the bottom portion of the anode 11. In some embodiments, the first plurality of through holes 111 are disposed in a plane perpendicular to a plane of the second plurality of through holes. The first and second plurality of through holes 111, 113 allow for good airflow through the vaporizing device 100. In other embodiments, more or fewer through holes can be used, and through holes can be placed at different locations to achieve the desired airflow.

The heating element or atomizer 6 includes an anode wire 60 and a cathode wire 61, that extend from a distal side of the atomizer 6. In some embodiments, the atomizer can include a conductive coil. In some embodiments, the atomizer can include a ceramic core surrounding the conductive coil. In some embodiments, the atomizer can be a porous ceramic core. As described, the non-woven wick 5 surrounding the atomizer 6 acts to wick or otherwise direct fluid or liquid within the reservoir to the atomizer 6. Upon contacting the atomizer 6, the fluid or liquid will be heated and atomized, producing vapor that can be inhaled.

As best seen in FIGS. 3, 5, and 9, the atomizer 6 is placed within the cavity 22 leaving a defined gap 40 between a top surface of the atomizer 6 and a top surface of the cavity 22. Specifically, a gap 40 of about or approximately 1.0 to 2.5 mm, such as 1.5, 1.7, 1.9, 2.0 mm, or a gap 40 within a range defined by any two of the foregoing values, is arranged between the top surface of the atomizer 6 and the top surface of the cavity 22. Without this gap 40, there is a risk that non-vaporized fluid or liquid could be pulled proximally through the device. This could lead to clogging of the device and inhalation of the non-vaporized liquid by a user, both of which are undesirable. Providing the gap 40 allows the fluid or liquid to be adequately vaporized, meaning only vapor will be pulled proximally through the device.

The atomizer 6 can be heated by flowing a current through a wire within the atomizer, such as through the anode wire 60 to the atomizer 6 and the cathode wire 61. When fluid contacts a surface of the atomizer 6 or a surface of any of the pores within the atomizer 6, the fluid will be atomized to produce vapor. In some embodiments, the atomizer 6 can have a porosity designed to more efficiently heat and atomize the fluid. In some embodiments, the atomizer 6 can have a porosity designed to decrease clogging of the pores.

As illustrated in FIG. 5, the reservoir 1 and base 9 are both mounted or connected to the center post 2. A distal end of the reservoir 1 connects to an outer surface of the distal end of the center post 2. Specifically, the distal end of the reservoir 1 connects to the distal end of the center post 2 via second sealing ring 4. The second sealing ring 4 sits on a distal side of the distal flange 21 and on an interior surface of the distal end of the reservoir. This arrangement seals the distal end of the reservoir 1, preventing fluid or liquid from leaking out of the distal end of the reservoir 1.

A proximal side of the base 9 abuts the distal end of the reservoir 1, with third sealing ring 8 sandwiched therebetween. This arrangement further seals the distal end of the reservoir 1, preventing fluid or liquid from leaking out of the distal end of the reservoir 1. Thus, the second and third sealing rings 4, 8 contribute to the substantially leakproof nature of the vaporizing devices.

FIG. 6 illustrates an example anode or electrode 11, according to embodiments of the present disclosure. In some embodiments, anode 11 is more generally an electrode to pass current to the heating element/atomizer 6 via the anode and cathode wires 60, 61. As illustrated in FIG. 6, a top portion of the anode defines a top cavity 110. The top cavity 110 defines a first plurality of through holes 111. In some embodiments, the first plurality of through holes 111 are disposed symmetrically about the top portion. A bottom portion of the anode 11 defines a bottom cavity 112. The bottom cavity 112 defines a second plurality of through holes 113. In some embodiments, the second plurality of through holes 113 are disposed symmetrically about the bottom portion.

The first and second plurality of through holes 111, 113 provide air flow through the anode 11 and through the device 100, more generally. The bottom portion of the anode 11 also includes a flange 114, disposed near the distal-most end of the anode 11. The insulator 10 is arranged on an upper surface of the flange 114.

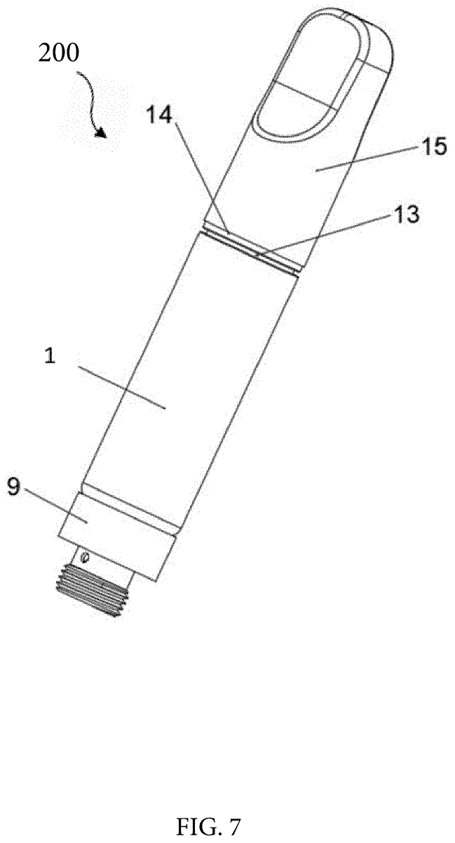

FIG. 7 illustrates another example of a vaporizing device, according to embodiments of the present disclosure. The disclosure relating to the vaporizing device 100 with relation to FIGS. 1-6 also applies to the vaporizing device of FIGS. 7-10, so like reference numbers will be used for like elements. As illustrated, the vaporizing device 200 includes a reservoir 1, a base 9, a mouthpiece 15, a mouthpiece locking structure 14, and a fourth sealing ring 13. As with the vaporizing device 100, the base 9 abuts a distal end of the reservoir 1. In some embodiments, the vaporizing device 200 is a leakproof device. In some embodiments, the vaporizing device 200 can be a cartridge or liquid reservoir.

The center post 2 is received by an interior of the reservoir 1. For example, the center post 2 can be positioned within the interior of the reservoir 1 in a sleeved or nested manner. The proximal end 30 of the center post 2 extends proximally beyond a proximal end of the reservoir 1. In some embodiments, the proximal end 30 engages with or receives the mouthpiece and/or mouthpiece locking structure. The distal end 35 of the center post 2 extends distally beyond a distal end of the reservoir 1. In this way, the distal end 35 of the center post 2 can engage with the base 9.

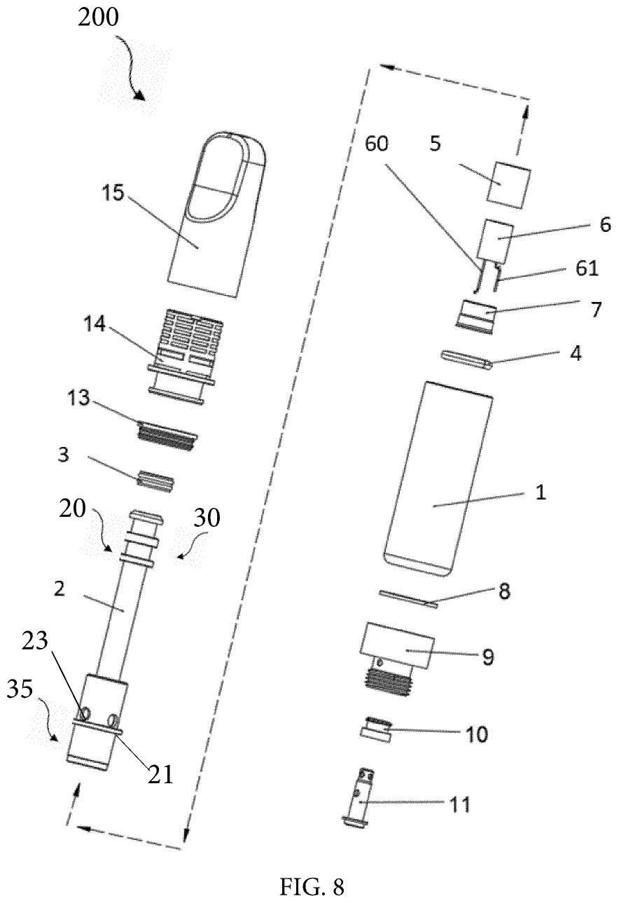

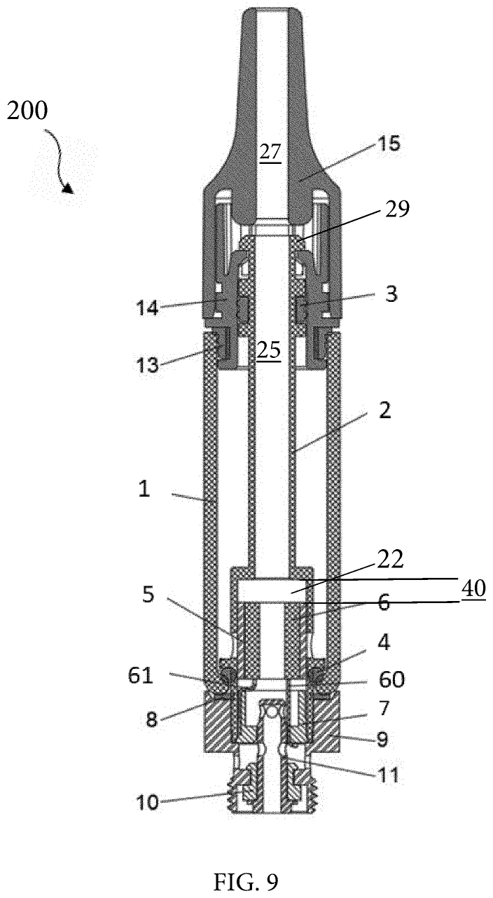

FIG. 8 illustrates an exploded view of the vaporizing device of FIG. 7. As illustrated, the vaporizing device 200 includes the reservoir 1, a center post 2, and the base 9. Similar to center post 2 of FIG. 2, the center post 2 includes a pair of proximal flanges 20 disposed near a proximal end 30 of the center post 2. A distal end 35 of the center post 2 defines a cavity 22 (better illustrated in FIG. 9) and one or more voids 23. The distal end 35 also includes a distal flange 21. In some embodiments, the one or more voids are disposed just proximal to the distal flange 21.

Also illustrated are various internal components of the vaporizing device 200 that are housed or otherwise disposed within (i) the cavity 22 of the distal end 35 of the center post 2, (ii) the base 9, or (iii) some combination thereof. The internal components can include, at least, a non-woven wick 5, an atomizer 6 having an anode wire 60 and a cathode wire 61, and an insulating sleeve 7. The internal components can also include an anode 11 and an insulator 10. Also illustrated are second and third sealing rings 4, 8 which assist in providing leakproof and other seals during manufacture, assembly, and/or use of the vaporizing device 200. The vaporizing device 200 also includes a mouthpiece 15, a mouthpiece locking structure 14, and a fourth sealing ring 13. The mouthpiece locking structure 14 and the fourth sealing ring 13 connect the mouthpiece 15 to the proximal end 30 of the center post 2.

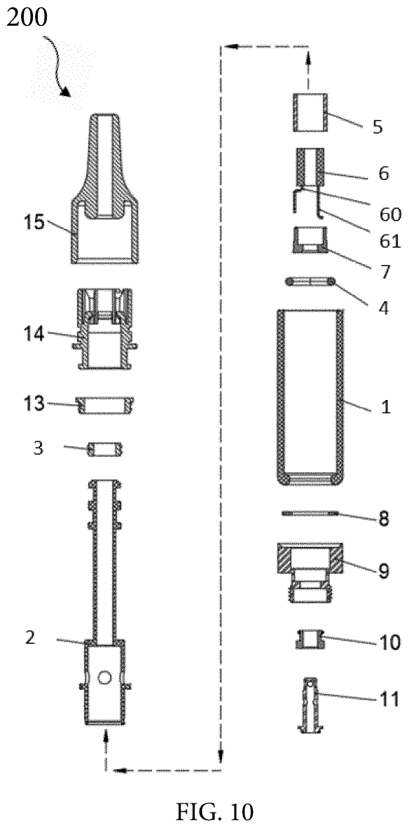

FIG. 9 illustrates a cross-sectional view and FIG. 10 illustrates a cross-sectional exploded view of the vaporizing device of FIG. 7. FIG. 9 illustrates a view similar to the that illustrated in FIG. 3. Referring to FIGS. 9 and 10, the mouthpiece 15 engages the proximal end of the center post 2 via the mouthpiece locking structure 14. Specifically, the first sealing ring 3 (which is disposed between the pair of proximal flanges 20) engages with an inner surface of the mouthpiece locking structure 14. The fourth sealing ring 13 is disposed between an interior proximal surface of the reservoir 1 and an outer distal surface of the mouthpiece locking structure 14. The mouthpiece locking structure 14 engages with the proximal end of the reservoir 1 through a press or friction fit via fourth sealing ring 13. Similarly, the mouthpiece locking structure 14 engages with the proximal end of the center post 2 through a press or friction fit via first sealing ring 3.

The mouthpiece 15 defines an internal channel 27. In some embodiments, the mouthpiece 15 aligns over the center post 2 such that an internal channel 25 of the center post 2 aligns with the internal channel 27 of the mouthpiece 15. The internal channels 25, 27 together create a path for vaporized substances to flow proximally from the atomizer 6, through the internal channels 25, 27 and out of the device 200.

In some embodiments, the mouthpiece locking structure 14 is grooved to accommodate the fourth sealing ring 13. Further, grooves of the mouthpiece locking structure 14 can provide friction or grip between the mouthpiece locking structure 14 and the mouthpiece 15. Additionally, as illustrated, internal wings of the mouthpiece locking structure 14 engage the most proximal end of the center post 2, which may have a lip 29 or other overhang for such engagement.

Similar to the arrangement described and illustrated in FIG. 3, the cavity 22 of the distal end of the center post 2 receives the atomizer 6. The atomizer 6 can be wrapped with a non-woven wick 5. Placement of the non-woven wick 5 aligns with the one or more voids 23, placing the atomizer 6 in fluid communication with the reservoir 1. Specifically, a fluid or liquid within the reservoir 1 can flow through the one or more voids 23 and into the non-woven wick 5. The non-woven wick 5 wicks or otherwise directs the fluid or liquid toward the atomizer 6, where the fluid or liquid can be atomized. The produced vapor can then be drawn proximally, through the internal channels 25, 27, and out of the device 20.

Also disposed within the cavity 22 is an insulating sleeve 7 and a top portion of the anode 11. As before, the insulating sleeve 7 is positioned within the cavity 22, such that an anode wire 60 of the atomizer 6 is sandwiched between the top portion of the anode 11 and an inner surface of the insulating sleeve 7. This placement ensures good contact between the anode 11 and the anode wire 60, and, thus, good electrical conductivity for the atomizer 6. A cathode wire 61 of the atomizer 6 is sandwiched between an inner surface of the cavity 22 and the insulating sleeve 7. This placement prevents potential contact of the cathode wire 61 and the anode wire 60, ensuring current flows from the anode 11 through the anode wire 60 to the atomizer 6. Isolation of the cathode wire 61 also prevents the device from short-circuiting.

The insulator 10 is disposed around the bottom portion of the anode 11 and serves to insulate the anode 11 from, for example, the base 9. This isolation also contributes to the electrical conductivity for the device 200, ensuring current flows from the anode 11 through the anode wire 60 to the atomizer 6.

Also as before, the reservoir 1 is mounted to the center post 2 via second sealing ring 4, and the base is mounted to the center post via third sealing ring 8. The second sealing ring 4 is disposed on a distal side of the distal flange 21.

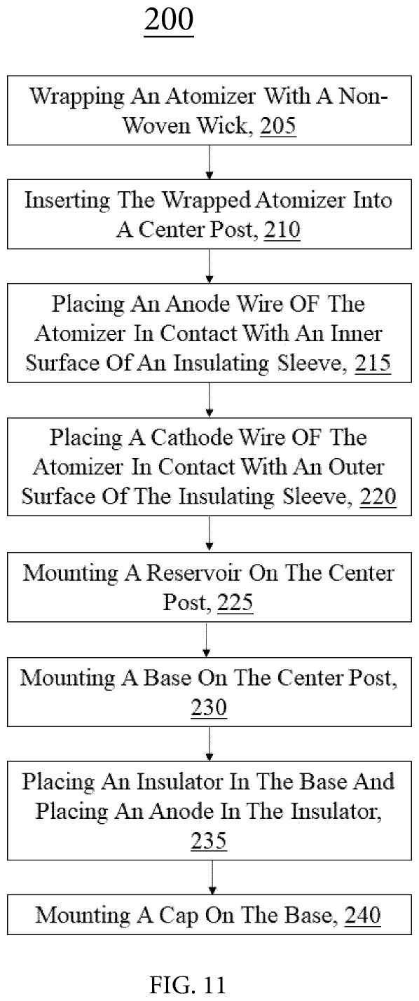

FIG. 11 illustrates a flowchart of an example method 200 for manufacturing a vaporizing device, according to embodiments of the present disclosure. In some embodiments, the method 200 includes wrapping an atomizer with a non-woven wick, at 205. The atomizer can be atomizer 6 and the non-woven wick can be non-woven wick 5 illustrated in FIGS. 1-10. The non-woven wick can be wrapped around an outer wall or surface of the atomizer.

The method 200 can also include inserting the wrapped atomizer into a center post, at 210. For example, the wrapped atomizer can be inserted into a distal cavity of the center post, such as cavity 22 illustrated in FIG. 5. The method 200 additionally includes placing an anode wire of the atomizer in contact with an inner surface of an insulating sleeve, at 215. In some embodiments, the insulating sleeve is inserted into the distal cavity following insertion of the wrapped atomizer. The anode wire of the atomizer can then be placed on the inner surface of the insulating sleeve. Placing the anode wire on the inner surface of the insulating sleeve positions the anode wire to be in contact with an electrode. Such positioning will allow the electrode to transfer current to the anode wire, thereby powering the atomizer.

The method 200 additionally includes placing a cathode wire of the atomizer in contact with an outer surface of an insulating sleeve, at 220. As before, the insulating sleeve may be disposed within the cavity prior to placing the cathode wire on the outer surface. This places the cathode wire in position between the outer surface of the insulating sleeve and an inner surface of the distal cavity of the center post. Such positioning will isolate the cathode wire from the anode wire, ensuring a good flow of current through the anode wire and to the atomizer.

The method 200 includes mounting a reservoir on the center post, at 225, and mounting a base on the center post, at 230. In some embodiments, the reservoir is mounted on the center post using a plurality of sealing rings (e.g., O-rings or gaskets). For example, as illustrated in FIGS. 3, 5, and 9, a second sealing ring is disposed between an inner surface of a distal end of the reservoir and an outer surface of the distal end of the center post. A third sealing ring is disposed between the distal end of the reservoir and a proximal end of the base. The second and third sealing rings serve to mount and connect the reservoir to the center post. Placement of the second and third sealing rings not only secures the reservoir and base to the center post, but also seals off any potential points of leakage for the liquid inside the reservoir. For example, placement of the second sealing ring ensures liquid will not leak from the distal end of the reservoir and into the base (or out of the reservoir).

The method 200 also includes placing an insulator in the base and placing an electrode (e.g., an anode) in the insulator, at 235. In some embodiments, the insulator and anode are placed within the base prior to securing the base to the center post. The insulator is placed within the base such that the insulator surrounds and receives at least a portion of the anode. The insulator acts to insulate the anode from the base and ensures current is delivered through the anode to the anode and cathode wires of the atomizer. Insulting the anode ensures there is only one path for the current to flow, resulting in a strong current to adequately power the atomizer. Placing the insulator and anode within the base positions the anode to be in contact with the anode wire of the atomizer, resulting in an electrical connection.

The method 200 includes mounting a cap or endcap on the base, at 240. In some embodiments, the cap is a silicone cap and is simply pressed over the free end of the base. In some embodiments, the cap includes internal threads to mate with external threads on the free end of the base.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. Portions of a vaping device that are closer to a user when the vaping device is in use are referred to as more “proximal” (i.e., the proximal mouthpiece which is within a user's mouth when the vaping device is in use) while surfaces that are farther away from the user when the device is in use are referred to as “distal.”

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A vaporizing device comprising:
a center post defining an internal channel and having proximal and distal ends, the distal end defining a cavity for receiving an atomizer;
a reservoir for receiving the center post within an interior of the reservoir, the proximal end of the center post extending proximally beyond a proximal end of the reservoir;
the atomizer positioned in the cavity of the distal end of the center post and in liquid communication with the reservoir, the atomizer in connection with an anode wire and a cathode wire;
a non-woven wick surrounding the atomizer, such that a fluid from the reservoir passes through one or more voids in the distal end of the center post, through the non-woven wick, and to the atomizer to be atomized and drawn proximally through the internal channel of the center post;
a base in connection with the distal end of the center post, the base abutting a distal end of the reservoir;
an insulating sleeve within the cavity of the distal end of the center post, the insulating sleeve for receiving an anode,
the anode having a top portion and a bottom portion, the top portion defining a first channel having a first plurality of through holes and the bottom portion defining a second channel having a second plurality of through holes;
wherein the anode wire is positioned between the insulating sleeve and the top portion of the anode, and the cathode wire is positioned between the insulating sleeve and an interior surface of the cavity of the distal end of the center post;
an insulator between the bottom portion of the anode and the base; and
a mouthpiece locking structure for attaching a mouthpiece to the proximal end of the center post.

2. The vaporizing device of claim 1, wherein the center post comprises a pair of proximal flanges disposed near the proximal end and a distal flange disposed near the distal end.

3. The vaporizing device of claim 2, wherein a first sealing ring is disposed between the pair of proximal flanges, the first sealing ring for engaging a portion of the mouthpiece locking structure.

4. The vaporizing device of claim 1, further comprising a cap in connection with a distal end of the base.

5. The vaporizing device of claim 1, wherein the atomizer comprises a ceramic heating core.

6. The vaporizing device of claim 1, wherein the atomizer comprises a porous ceramic heating core.

7. The vaporizing device of claim 6, wherein the fluid from the reservoir passes through one or more voids in the distal end of the center post, through the non-woven wick, and into a plurality of pores of the porous ceramic heating core to be atomized and drawn proximally through the internal channel of the center post.

8. The vaporizing device of claim 1, further comprising a fourth sealing ring disposed between a pair of distal flanges of the mouthpiece locking structure, the fourth sealing ring for engaging an interior surface of the proximal end of the reservoir.

9. The vaporizing device of claim 1, wherein the mouthpiece engages with the mouthpiece locking structure via a press and/or friction fit.

10. The vaporizing device of claim 1, wherein the mouthpiece locking structure engages with the proximal end of the center post via a press and/or friction fit.

11. The vaporizing device of claim 1, wherein the mouthpiece defines a channel, the channel being in fluid communication with the internal channel of the center post.

12. The vaporizing device of claim 1, wherein a gap is disposed between a top surface of the cavity of the distal end of the center post and a top surface of the atomizer, the gap being approximately 1.0 to 3.0 mm, such as 1.5, 2.0, 2.5, 2.74 mm, or a gap within a range defined by any two of the foregoing values.

13. A vaporizing device comprising:
a center post defining an internal channel and having proximal and distal ends, the distal end defining a cavity for receiving a heating element,
the heating element positioned within the cavity of the distal end, the heating element having an anode wire and a cathode wire;
a reservoir for receiving the center post within an interior of the reservoir, the reservoir in fluid communication with the heating element;
a base in connection with the distal end of the center post, the base abutting a distal end of the reservoir;
an insulating sleeve within the cavity of the distal end of the center post, the insulating sleeve for receiving an anode, the anode having a top portion and a bottom portion,
wherein the anode wire is positioned between the insulating sleeve and the top portion of the anode, and the cathode wire is positioned between the insulating sleeve and an interior surface of the cavity of the distal end of the center post; and
an insulator between the bottom portion of the anode and the base.

14. The vaporizing device of claim 13, further comprising a wick surrounding the heating element, such that a fluid from the reservoir passes through one or more voids in the distal end of the center post, through the wick, and to the heating element to be vaporized and drawn proximally through the internal channel of the center post.

15. The vaporizing device of claim 13, wherein the proximal end of the center post extends proximally beyond a proximal end of the reservoir for engaging a mouthpiece.

16. The vaporizing device of claim 15, wherein the mouthpiece engages with the proximal end of the center post via a press and/or friction fit.

17. The vaporizing device of claim 13, wherein a gap is disposed between a top surface of the cavity of the distal end of the center post and a top surface of the heating element, the gap being about 1.0 to 3.0 mm, such as 1.5, 2.0, 2.5, 2.74 mm, or a gap within a range defined by any two of the foregoing values.

18. The vaporizing device of claim 13, further comprising:
a first sealing ring disposed between a pair of proximal flanges disposed near the proximal end of the center post;
a second sealing ring disposed between the interior of the reservoir and an outer surface of the distal end of the center post; and
a third sealing ring disposed between a distal end of the reservoir and a proximal end of the base.

19. The vaporizing device of claim 13, wherein positioning the anode wire between the insulating sleeve and the top portion of the anode keeps the anode wire pressed against or in contact with an external surface of the top portion of the anode.

20. A vaporizing device comprising:
a center post defining an internal channel and having proximal and distal ends, the distal end defining a cavity for receiving an atomizer,
the atomizer positioned within the cavity of the distal end, the atomizer in connection with an anode wire and a cathode wire;
a reservoir for receiving at least a portion of the center post within an interior of the reservoir, the reservoir in fluid communication with the atomizer;
a non-woven sleeve surrounding the atomizer;
a base in connection with the distal end of the center post, the base abutting a distal end of the reservoir;
an insulating sleeve within the cavity of the distal end of the center post, the insulating sleeve for receiving an anode, the anode having a top portion and a bottom portion,
wherein the anode wire is positioned between the insulating sleeve and the top portion of the anode, and the cathode wire is positioned between the insulating sleeve and an interior surface of the cavity of the distal end of the center post; and
an insulator between the bottom portion of the anode and the base.
